(19) United States
(12) Patent Application Publication
(10) Pub. No.: US 2011/0031643 A1
(43) Pub. Date: Feb. 10, 2011

(54) METHOD AND DEVICE FOR PERFORATING A THERMOPLASTIC COMPOSITE

(75) Inventors: Gregory Hache, Molieres (FR); Christophe Saint Martin, Saint-Bressou (FR)

Correspondence Address: YOUNG & THOMPSON, 209 Madison Street, Suite 500, Alexandria, VA, 22314, US

(73) Assignee: HACOMA, Lacapelle Marival (FR)

(21) Appl. No.: 12/864,681

(22) PCT Filed: Jan. 16, 2009
(86) PCT No.: PCT/EP09/50461

§ 371 Date: Oct. 27, 2010

(30) Foreign Application Priority Data
Jan. 28, 2008 (FR) 0850510

(51) Int. Cl. B29C 70/28; B29C 70/06

(52) U.S. Cl. 264/154; 425/290

(57) ABSTRACT

To produce a hole in a part (1) made of a thermoplastic composite, the part is locally heated to a plastic forming temperature T_{f} and the fibres (10) of the composite are progressively moved apart at the same time as the matrix (11) in the plastic state is pushed back radially relative to the axis of the hole, firstly to form a starter hole and then to enlarge the starter hole up to the desired hole dimensions. When the hole has been produced, an operation for sizing the thickness of the part in the hole region is carried out without removal of material because of the excess material pushed back from the hole. A tool having a needle (31), the cross section of which progressively changes between a tapered end (311) suitable for producing the starter hole and a heel (312), is used to produce the hole by the method.

This invention pertains to the field of the manufacturing of parts made of composite material.

More particularly, the invention relates to a process and a device for making precision holes in composite materials that comprise fibers that are kept in a resin having thermoplastic properties.

Most often for assembly requirements but not exclusively, the parts of structures comprise holes that are used to pass attachments through. These holes should be made with relatively tight tolerances to ensure the quality of the assemblies, in particular when the assemblies are subjected to significant forces.

In modern structures, it is common that parts are made of composite material comprising mineral or organic, glass, carbon, or Kevlar® . . . fibers that are kept in an organic resin.

Holes are made in such composite parts either during the manufacturing of the part that is considered in general by means of an insert kept in a mold that is used during the production of the part or most often by perforation of the part that is made, i.e., when the organic resin that holds the fibers is hardened.

The technique that consists in placing an insert in a mold during the production of the part proves relatively difficult to use when the part itself has a complex shape, and in addition, it is difficult to ensure the precise position of the hole, for example a precision that is less than one-tenth of a millimeter, because of the risks of deformation of the part when the latter is taken from the mold.

The perforation technique makes it possible to make holes in the part at precise locations by using the techniques that are closely related to conventional techniques that are used for making holes in parts made of metal materials, with the proviso of using perforating tools and cutting parameters that are suitable for the composite materials that are generally very abrasive and that, without precautions, quickly degrade the characteristics of the cutting tools during the perforating operations that prove long and difficult to implement.

In addition to the necessity for suitable tools and processes, the perforating technique exhibits the drawback of cutting the fibers that provide its resistance to the part of the composite material at the location of the hole and requires precautions for limiting risks of delamination of the part in particular on the side emerging from the hole.

These phenomena have the effect of reducing the resistance of the part and in practice, the designer increases the thicknesses of the part, at least in the zones that comprise holes, to compensate for the reduction of resistance.

The result is an increase in the mass of the part that is detrimental in numerous applications where the composite materials are used.

This invention specifically has the object of a method and a device for making precision perforations in parts made of composite material without damaging fibers at the perforation hole.

The process makes it possible to make a hole in one part, essentially formed by fibers, in particular long fibers that are kept in a matrix, between a first surface, so-called upper surface, through which the hole is made, and a second surface, so-called lower surface, through which the hole emerges, when the matrix essentially consists of a thermoplastic material, exhibiting a plastic state when it is brought to a temperature Tf, so-called forming temperature, and exhibiting a non-plastic state when it is at a temperature Tu, so-called temperature of use, less than Tf.

To prevent the breaking of fibers and the degradation of the performances of the part, the process comprises the stages of:
a) Locally heating at least at the location of the hole to produce the matrix of the part at the temperature Tf;
b) Moving apart the fibers held by the matrix at the location that is desired for the hole by radially pushing back the material in the plastic state from said matrix relative to a longitudinal axis of the hole in order to form a starter hole from a cross-section that is lower than a cross-section that is desired for the hole;
c) Heating, if necessary, the material of the matrix around the starter hole to the temperature Tf and gradually moving apart the fibers and pushing back the material in the plastic state from the matrix until reaching the cross-section that is desired for the hole;
d) Cooling the material of the matrix to a temperature Tu, or at least to a temperature that is lower than Tf for which said matrix no longer has a thermoplastic property, by holding the material of the pushed-back matrix and the fibers that are moved apart around the hole that is made during preceding stages.

To avoid deforming the part in the direction of the axis of the hole during the perforation operation, the part 1 is advantageously kept in the zone of the hole to be made by a counter-pushed plate while the hole is being made.

To deal with the excess thickness of the part created around the hole by the material that is pushed back from the location of the hole—after the formation of the hole in stage c) and before the cooling of the part in stage d)—preferably a stage for calibrating the thickness of the part in a peripheral zone of the hole is implemented during which pressure is exerted between the upper surface and the lower surface to distribute the material of the part that is pushed back from the location of the hole toward the peripheral zone.

When a particular shape is to be given to the hole such as a countersink at the edge of the hole or a thread of a tapping, the particular shape is advantageously shaped by an indentation of a shape that is applied during the calibration stage.

In a particular embodiment after the formation of the hole in stage c) and before the cooling of the part in stage d), and if necessary before the calibration stage of the part, a stage is implemented for insertion—into the hole that is made—of an insert comprising a hole that makes it possible to effectively make integral the insert and the part in a single stage with the perforation operation.

If necessary, the hole of the insert, when the insert is itself made of a thermoformable material, is shaped by an indentation of a shape that is applied during the calibration stage.

When the perforation operation is carried out in a phase for manufacturing the part during which the part is brought to a temperature that is greater than or equal to Tf, the perforation operation is advantageously carried out without an additional heating stage.

When it is necessary to raise the temperature of the part, the heating of the part at the location of the hole is carried out locally during the perforation operation by means of heating by radiation or by contact conduction or by ultrasound.

For the implementation of the process, the invention also relates to a perforation device for making a hole in the thermoplastic composite material part that comprises a needle comprising:
i) On the side of one free end of the needle, a tapered end of an essentially constant cross-section that is lower than the cross-section of the hole that is to be made in the part and with end length Le;
ii) On the side of the other end, a heel of a cross-section that is essentially constant and equal to the cross-section of the hole that is to be made and with a heel length Lt;
iii) Between the tapered end and the heel, a scalable cross-section zone in which the cross-section of the needle gradually changes from the cross-section of the tapered end to the cross-section of the heel.

To obtain a cylindrical hole in the part, the heel length Lt is greater than or equal to the thickness of the part at the location of the hole that is to be made.

For its manipulation during different perforation operations, the needle is integral at the heel with a body, whereby the body forms a shoulder relative to the heel, and whereby said shoulder forms a support surface on a peripheral zone of the hole when the needle is pushed into the part to form the hole.

To facilitate the penetration of the needle and the moving apart of the fibers in an embodiment, the needle is vibrating, subjected to low-amplitude vibrations.

To create particular forms such as a countersink or a threading at the hole, the body comprises a form that is designed to allow an indentation that corresponds to the geometry of said form in the part on one or more of the edges of the hole or in the hole.

So as to simply replace the needle that may be worn out or to change its characteristics, the body and the needle can be separated and assembled by means of a cylindrical extension of the body or the needle.

In this case, when it is desired to put an insert into the hole that is made, the cylindrical extension comprises an intermediate zone of a cross-section that is lower than the cross-section of the heel, an intermediate zone that is designed to accommodate the insert that has to be set in the hole that is made in the part, the cross-section of the intermediate zone corresponding to the shapes and dimensions of a hole in the insert, and the shape and the dimensions of the cross-section of the heel corresponding to shapes and dimensions of a cross-section outside of the insert before its installation.

In an embodiment that is advantageous for imposing shapes and thicknesses onto the insert and onto the part in the zone of the insert and for promoting adhesion between the insert and the part, the body and the needle comprise—in assembled position—at least a first offset position in which the insert is not deformed and a second closer position in which the insert is deformed when the insert can be shaped plastically at the temperature Tf.

Advantageously, the needle is combined with means for heating by radiation or by conduction or by ultrasound to ensure heating to the forming temperature of the zone of the part in which the perforation device is to make a hole.

To prevent the part from being deformed by the forces exerted by the needle during its penetration into the zone of the part in the plastic state, preferably the device comprises a counter-pushed plate. The counter-pushed plate is designed to be placed on the lower surface of the part in the zone of the hole that is to be made. The counter-pushed plate itself comprises a hole with a cross-section that is at least equal to the cross-section of the heel, whereby the axis of said hole and the axis of the needle are close enough to one another to allow the needle to make the perforation in the part without being restricted by the counter-pushed plate.

The description that is presented in detail of an embodiment of the invention given in reference in the figures that show:

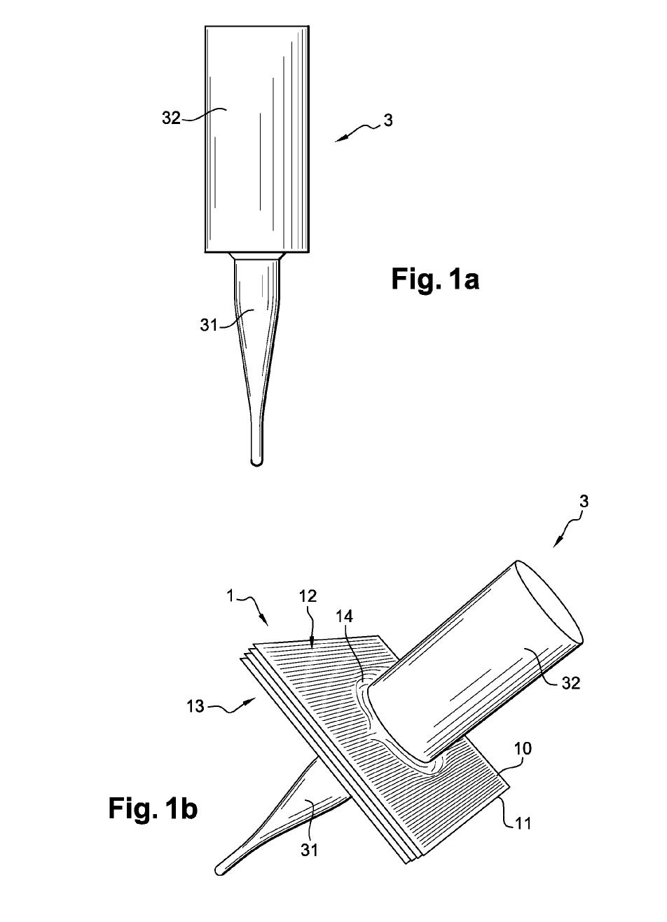

FIGS. 1a and 1b: An example of a perforating tool of the invention according to a first embodiment, only in profile view in FIG. 1a and in perspective view during an operation for perforating a part in FIG. 1b;

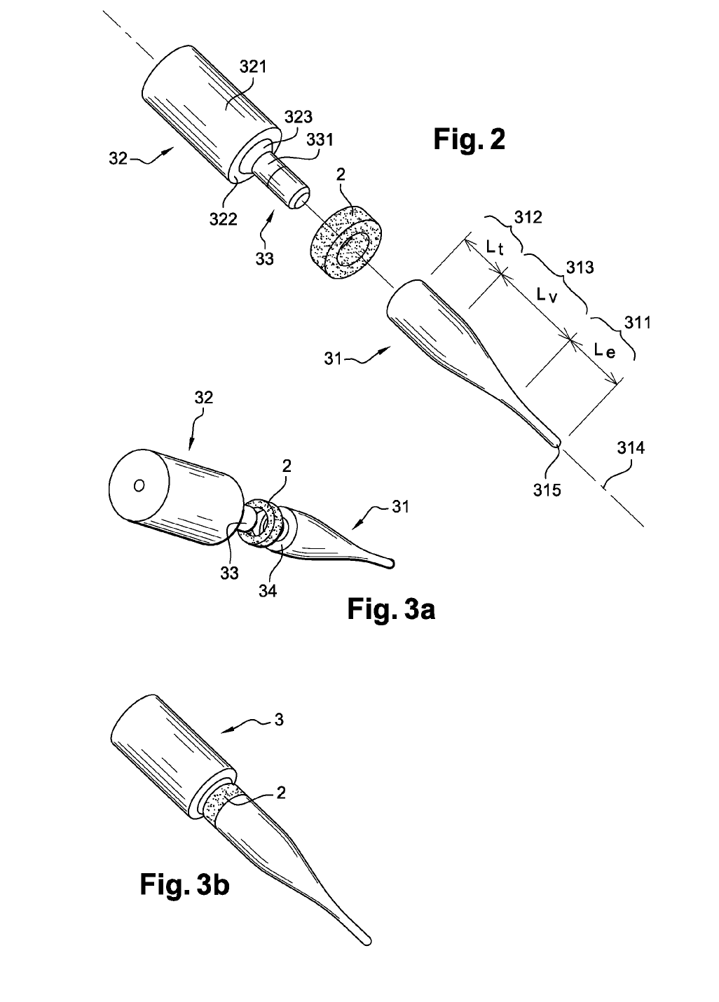

FIG. 2: An example of a second embodiment of a perforating tool according to the invention that comprises two disassembled elements;

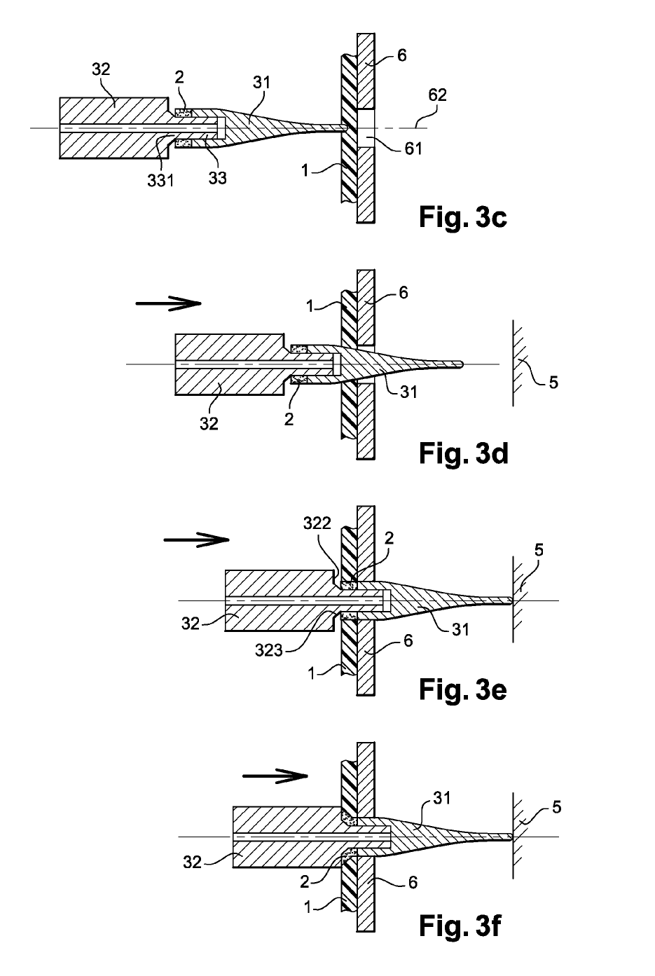

FIG. 3a to FIG. 3f: A diagrammatic presentation of a perforation operation with installation of an insert using a perforating tool according to the example of FIG. 2;

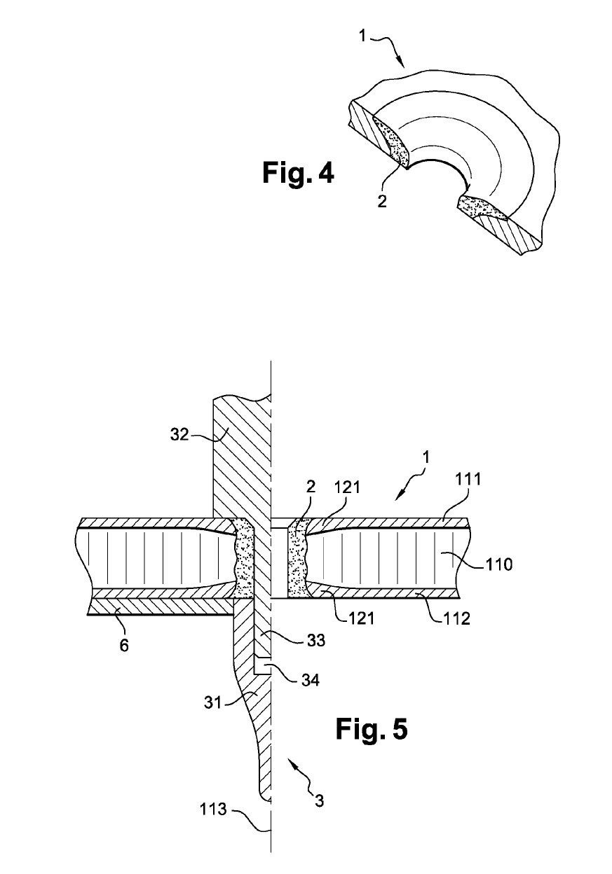

FIG. 4: A perspective view of a cutaway of a part that is obtained after a perforation following the process of the invention with installation of an insert;

FIG. 5: A cross-section that illustrates the application of the process in the case of a part that is made with a sandwich structure, a half-section being presented with the tool at the end of the perforation operation and the other half-section being presented once the tool is disengaged.

The invention has as its object a process and a device for making precision holes in a part 1 made of composite material that comprises fibers 10, in particular but not exclusively long fibers, kept in a hard organic matrix 11 that has thermoplastic properties.

Thermoplastic properties of an organic matrix are defined in this description as that the material that forms the matrix of the composite material is able to be brought into a relatively fluid state, a so-called plastic state, by an elevation of the temperature to a so-called temperature-forming value Tf, a state in which said matrix is deformable without losing expected physico-chemical and mechanical characteristics in the part 1 when said part is brought back to a temperature that is lower than Tf, in particular to a temperature Tu that is provided for the use of the part.

Particular families of composite materials that have such characteristics are combined under the general designation of “thermoplastic composites” and comprise matrices that are deformable when the temperature is brought to a sufficient value, which depends on the type of organic material, and they regain their mechanical properties by hardening when the temperature is again lowered to a temperature corresponding to a temperature for using the part. These thermoplastic composites most often come in a semi-open state in the form of plates that are used for the production of parts by hot forming techniques, in particular forming in molds.

A composite material part 1 that comprises fibers 10 that are held in a matrix 11 that has thermoplastic characteristics comprises two surfaces between which an emergent hole is to be made:
A first surface, so-called upper surface 12, through which the hole is to be made;
A second surface, so-called lower surface 13, through which the hole is to emerge.

According to the process of the invention, in order to make the hole in the part 1 that is made of thermoplastic composite material:
In a first stage, the part 1 is heated, at least locally, at the location of the hole to be made to bring the matrix 11 to the temperature Tf for which said matrix comprises desired plastic characteristics;
In a second stage, the fibers 10 that are held by the matrix 11 are moved apart at the location that is desired for the hole by pushing back radially, relative to a longitudinal axis of the hole, the material that became plastic from said matrix and by deforming said fibers to form a starter hole, i.e., a hole with a cross-section that is essentially lower than the hole that is to be made;
In a third stage, the material of the matrix 11 around the starter hole is brought approximately to the temperature Tf, and the starter hole is gradually enlarged by continuing to essentially radially push back the material from the matrix 11 and to deform the fibers 10 until reaching the cross-section that is desired for the hole.
In a fourth stage, the temperature of the part around the hole is brought back to a temperature Tu for which the matrix 11 does not have a plastic nature at the same time that the material of the matrix and the fibers are moved apart so as not to reclose, even partially, the hole.

In the process, the fibers 10 are deformed around the hole so that said fibers are not cut or broken, or at least so that the quantity of broken fibers is the smallest possible. Such a result is obtained when the deformation is carried out by radially pushing back the fibers gradually and in combination with the local rise in temperature that has the effect of making the matrix 11 malleable.

In a first embodiment of the process, the material of the matrix is heated in the immediate proximity of the zone of the matrix that has to be deformed as the deformation that is carried out for forming the hole proceeds so as to limit the axial deformations of the zones of the part 1 that are close to the hole during the perforation operation.

In a second embodiment of the process, the part 1 is heated in a zone that is at least equal to the zone that has to be heated for making the hole before beginning the stages for pushing back from the matrix and moving away the fibers. In this mode, the part advantageously is locally positioned against a support 33 that is placed on the lower surface 13 that holds the part 1 and prevents said part, locally in a plastic state, from being deformed in the axial direction while the hole is being made.

In a particular application of the process, an insert 2, i.e., an attached element that has the shape of a ring, is placed in the hole that is made, before the fourth stage of the process, whereby the material of the part and the material of the insert are made integral when the matrix 11 is at the temperature Tf at which said matrix is plastic by application of pressure on the material of the part and/or the insert before the temperature is lowered.

In this application, the hole is made according to the process in the thermoplastic material of the part with a diameter that is approximately equal to the diameter of the insert.

The insert 2 makes it possible to reinforce, if necessary, the part 1 in the zone of the hole and, by a selection of the material of the insert, to implement galvanic insulation of an attachment that passes through the hole of the material of the part. For example, an insert that is made in a composite material based on glass fiber or aramid fiber makes it possible to insulate an attachment that is made of a metal alloy that is sensitive to corrosion induced by the carbon of a part that is made of a composite material based on carbon fibers.

In a preferred embodiment of the process, a peripheral zone 14 of the part 1 around the hole during the production is subjected, when the hole is at the desired diameter, i.e., at the end of the third stage of the process, and, if necessary, after the installation of an insert 2, to pressure between the upper surface 12 and the lower surface 13 so that the material that is initially at the location of the hole, and pushed back into the peripheral zone 14 around which it forms an excessive thickness, is distributed, and so that a defined thickness of the part 1 in the peripheral zone 14 is obtained.

This stage, so-called thickness calibration stage, is carried out before the fourth stage, i.e., when the material of the matrix 11 in the peripheral zone 14 also has plastic properties because of its temperature and makes it possible to obtain a perfectly defined thickness by managing the distribution of the material that is locally in excess because of making the hole that is made without removing material.

In a particular embodiment of this thickness calibration stage, pressure is exerted on the part 1 in the peripheral zone 14 so as to shape said peripheral zone based on the use that is to be made of the hole.

For example, when the hole is to accommodate a milled-head attachment for the requirements of an assembly, the peripheral zone is shaped to reproduce, at the hole, the countersink that is suitable to the attachment.

The hole that is made by the process is most often a circular hole that is defined by a diameter; however, the process advantageously applies to holes of any shape.

In a preferred embodiment, so as to implement the process of the invention, a perforation tool 3 comprises a needle 31 that is designed to pass through the part 1 to make the hole.

The description of the perforation tool 3 and its constituent parts will be better understood by considering that said perforation tool is pushed into the part 1, brought locally to the temperature Tf, at the location of the hole to be made in application of the above-described process to make a starter hole and to enlarge said starter hole to obtain a hole of the desired cross-section.

In a general embodiment, the needle comprises a tapered end 311, i.e., an end of a relatively small cross-section relative to the cross-section of the hole that is to be made in the part, and comprises, opposite the tapered end 311 along an axis 314 of the needle, a heel 312, i.e., a cylindrical zone of length Lt, whose cross-section corresponds to the cross-section that is desired for the hole that is to be made.

Between the tapered end 311 and the heel 312, the needle comprises a zone of non-constant cross-sections along the axis 314, a so-called scalable zone 313 of length Lv, in which the cross-section of the needle changes essentially continuously between the cross-section of the tapered end 311 and the cross-section of the heel 312.

The tapered end 311 of the needle comprises a free end 315 of the side of the needle that is opposite to the heel 312, whose shape is preferably a pointed shape, i.e., said end corresponds approximately to a terminal cone, or else a blunt shape, i.e., said end corresponds essentially to a spherical or rounded terminal form.

The selection of a particular shape of free end 315 is dictated by considerations that are linked to the materials that are used and/or to the method for supplying energy for heating the part and/or to the number of perforations having to be done with a given needle.

The length Lt of the heel corresponds at least to the thickness of the part at the location of the hole, in practice at least to the length of the hole corresponding to a constant cross-section.

In most of the cases, the holes that are made are circular, and in these cases, the right cross-section of the heel is circular.

However, the process and the perforation tool are used to make holes of non-circular cross-sections, for example holes of elongated shapes, to meet, for example, requirements of adjustment or mounting tolerance, or holes of polygonal cross-sections. To obtain holes of non-circular cross-sections, the cross-section of the heel 312 is made with the shape that is suitable, i.e., with a cross-section that corresponds to the cross-section of the hole that is to be made.

The tapered end 311 preferably comprises a cross-section that is essentially constant, outside of the free end 315, over a length Le that is approximately equal to the thickness of the part 1 in the zone of the hole so as to make an emergent starter hole before enlarging said starter hole to the desired cross-section of the hole.

Even when the cross-section of the hole, and therefore the cross-section of the heel 312, is not circular, it may be preferable to make a circular starter hole to better control the pushing-back of the material from the matrix 11 and the moving apart of fibers 10 during the process of enlarging the starter hole, and in this case, the cross-section of the tapered end 311 is a priori circular.

The laws of variation of the cross-sections of the needle 31 in the scalable zone 313 between the cross-section of the tapered end 311 and that of the heel 312 in practice determine the manner in which the material is pushed back from the matrix 11 when the needle is pushed in and therefore make it possible, to a certain extent, to monitor the volume of material that is pushed back in different directions around an axis of the hole.

The perforation tool 3 also comprises a body 32 whose shape is not imposed by the process except at a connection with the needle 31.

The body 32 is integral with the needle 31 at the heel 312 of the needle and the side of the needle opposite to the tapered end 311.

The body 32 makes it possible to hold the needle 31 during the perforation operations of the part 1, i.e., it makes it possible to orient, to guide, and to apply the forces that are necessary to the needle to make the hole by pushing in the needle either with a manual support tool or by an automated machine such as a tool-carrying robot or such as a multi-axis numerical control machine.

When the needle 31, for the requirements of the implementation of the process, is used for supplying energy to the part 1 so as to heat the material of the matrix 11 locally, the body 32 advantageously comprises means for supplying the necessary quantities of heat to the needle.

The body 32 preferably has an essentially cylindrical part 321 at the connection with the heel 312 of the needle 31. Advantageously, the body has a shoulder 322 relative to the heel 312.

The shoulder 322 comes to rest on the part 1 when the needle 31 is totally pushed into the part 1, i.e., when the hole in said part has reached the desired cross-section, and the width of said shoulder is selected to cover the peripheral zone 14 in which the material of the part 1 that is pushed back during the formation of the hole by the needle 31 is to be distributed during a calibration of the thickness of the part 1 in said peripheral zone.

In a preferred embodiment, the perforation tool also comprises a counter-pushed plate 6 that comes to rest on the lower surface 13 of the part 1.

Said counter-pushed plate can take on numerous shapes, in particular because of the shape of the part 1 in the zone where a perforation operation is carried out, but it itself comprises a hole 61 whose cross-section corresponds approximately to the cross-section of the hole that is to be made and therefore of the needle 31 in the zone of the heel 312 so as to allow the needle 31 to pass through during the perforation operations.

The counter-pushed plate 6 and the needle 31 are arranged in such a way that the axis 314 of the needle and an axis 62 of the hole 61 of the counter-pushed plate are close or essentially merged, and the needle 31 is movable along the axis 314, 62 relative to said counter-pushed plate.

In one particular embodiment, the body or the counter-pushed plate comprises forms 323, 63 that are representative of indentations, for example tapered countersink forms that have to be made on one or more of the edges of the hole that is to be made.

In a preferred embodiment of the perforation tool 3, the needle 31 can be separated from the body 32 so as to be able to be easily replaced either because of wear and tear of the needle or to be able to use a needle that has different characteristics, for example a diameter of the heel 312.

In one particular embodiment of the perforation tool 3, said tool comprises vibration means that make it possible to make at least the needle 31 vibrate at a low amplitude, which has the effect of facilitating the advance of the needle when the perforation is being made while facilitating the rearrangement of the fibers 10, in particular in the case of long fibers, around the hole within the matrix 11.

In an embodiment that is suitable for carrying out a perforation with the installation of an insert 2 in the hole that is made, the needle 31 and the body 32 are assembled, as illustrated in FIGS. 2, 3a and 3b, in such a way that an intermediate zone 331 between the heel 312 and the shoulder 322 has a reduced cross-section relative to the cross-section of the heel over a length that is at least equal to the thickness of the part 1 in the zone of the hole that is to be made.

The cross-section of the intermediate zone 331 is determined by a desired cross-section of the hole inside the insert 2, and in this case, the cross-section of the heel 312 essentially corresponds to the outside cross-section of the insert for the installation of which the hole is made in the part as illustrated in FIG. 3.

An insert can be made with different technologies, in particular based on the type of parts in which it is incorporated and the type of use of the part.

The insert is, for example, in a known manner, a rigid insert, made of a metal material or of another material, with an established shape and dimensions that are not modified when the insert is installed by means of the perforation tool.

In another embodiment, the insert is made of a material that comprises a thermoplastic or thermosetting matrix, for example a woven form, advantageously in three directions, in the shape of a ring, as illustrated in FIG. 2, and impregnated with a thermoplastic or thermosetting resin.

In this case, the characteristics of the thermoplastic matrix of the insert with regard to the temperatures that make it possible to form the insert are selected in such a way that the insert can be formed at temperatures that are used effectively during the perforation operation.

Likewise, the characteristics of the thermosetting matrix of the insert, if necessary, are selected so that the material of said matrix is compatible with a forming at temperatures that are effectively used during the perforation operation and a simultaneous or subsequent baking operation that has the effect of making the insert permanently hard.

In this embodiment for the installation of a thermoplastic or thermosetting insert 2, advantageously the needle 31 and the heel 32 comprise at least two assembled positions, a first position, so-called offset position in which an insert 2 placed in the intermediate zone 331 is held without being deformed, and a second position, so-called closer position in which the insert placed in the intermediate zone 331 is subjected to pressure between the shoulder 322 and the heel 312, which has the result of obtaining a calibrated thickness, corresponding to a length of the hole, the insert, and, if necessary, of shaping the insert, for example, by recessing a shape 323 of the body or the needle, for example to form a beveled edge at the edge of the hole.

The pressure that is exerted on the part 1 in the peripheral zone 14 and on the insert 2 when the heel and the needle are brought close to one another has the effect not only of calibrating the thickness of the part and the insert in the zone of the hole but also making integral the materials of said part and said insert because of local pressure generated at the interface between the part and the insert during the calibration operation.

Advantageously, a cylindrical extension 33 of the body 32 works with a hole 34 with an equivalent cross-section of the needle 31, or, conversely, a cylindrical extension of the needle works with a hole with an equivalent cross-section of the body (solution not shown) to make it possible to separate the needle from the body so as, in a first step, to install an insert 2 in the intermediate zone 331, as illustrated in FIGS. 3a and 3b, and, in a second step after the perforation operation, to remove the tool 3 that encircles, as illustrated in FIG. 3f, the insert 2 after said insert is installed.

The cylindrical extension 33 also makes possible, when necessary, a relative movement of the body and the needle between near and far positions during a perforation sequence with installation of a thermoplastic or thermosetting insert.

The controlled movement of the needle 31 relative to the body 32 is achieved by any mechanical means or other means that makes it possible to control this movement.

Advantageously, the needle 31 is integral with a rod that penetrates the body 32, and activating means, not shown, act on the rod to modify the relative position of the needle and the body.

In another embodiment, the cylindrical extension 33 forms a piston of a jack whose chamber that is formed by said extension and the needle 31, or the body 32, is used to control the relative position of the body and the needle.

In another embodiment, the cylindrical extension 33 has a circular cross-section and comprises a threading, solution not shown, on a portion of its length that makes it possible to control the relative position of the body 32 and the needle 31 by a rotation between these two elements.

In another embodiment, means outside of the needle and the body are used.

For example, as illustrated in FIGS. 3c and 3d, a rear stop 5 limits the advance of the needle 31 at the end of the perforation operation in such a way that a force that is exerted on the body 32 causes the relative movement that is sought between said body and said needle.

In a particular embodiment of a perforation tool with installation of an insert that is formed during the perforation operation, the cylindrical extension 331 comprises a threading, not shown, in the zone of the insert 2 such that said threading is imprinted in the insert 2 that is made of a thermoplastic material or a thermosetting material during the installation of said insert so as to form a tapped hole.

In this case, the part of the tool 3 that comprises the extension 331 is removed after the perforation operation by unscrewing.

This example illustrates that, with or without an insert, holes of different shapes, other than circular cross-sections and also other than cylindrical cross-sections, are possible by the implementation of the process by means of the use of a tool of suitable shape, with the proviso that the shape of the hole makes it possible to remove the tool in one part or in two or more parts.

FIGS. 3a to 3f illustrate a sequence for making a hole in the part 1 with the installation of an insert 2.

In a first step, the body 32 and the needle 31 are separated, and the insert 2 is placed in the intermediate zone 331 of the extension 33 (FIG. 3a).

The body 32 and the needle 31 are then assembled to form the perforation tool 3 that carries the insert 2 (FIG. 3b).

The tool is then used according to the process for making a hole in the part 1, for example held by a counter-pushed plate 6, corresponding to the cross-section of the heel 312 of the needle by pushing the needle 31 into the part 1, locally at the forming temperature Tf (FIGS. 3c, 3d and 3e). The cross-section of the heel 312 also corresponds essentially to the cross-section of the insert 2 in such a way that when said heel of the needle has passed through the part 1, the insert is to occupy the hole that is made by the needle (FIG. 3e).

The body 32 is then brought closer to the needle 31, for example by stopping the advance of the needle by means of a stop 5 to calibrate the thickness of the peripheral zone of the hole between the shoulder 322 of the body and the counter-pushed plate 6 and to shape the hole of the insert based on the shape 323 of the shoulder 322 (FIG. 3f).

In a final stage, not shown, when the temperature drops below a value above which the dimensional stability of the material of the matrix, of the material of the part and of the insert would not be guaranteed, the needle 31 and the body 32 are separated to release the part 1 that comprises the hole with an insert as illustrated in cutaway view in FIG. 4.

The process is also applied in the case of parts 1 made of so-called sandwich composite that comprises, as illustrated in FIG. 5, a core 110 that consists of a low-density material, for example a foam or an alveolar material such as a honeycomb material, encompassed between two panels 111, 112 made of composite material that comprises fibers in a thermoplastic resin. In this case, the installation of an insert 2 proves particularly useful for improving the resistance to crushing in the zone of the hole, and a hole is advantageously made according to the process and with a perforating tool as described.

In the case of such a perforation of a sandwich material, the process, as illustrated in the left half-section of FIG. 5, is applied to carry out the perforation of the two panels 111, 112 successively along a common axis 113 with a tool 3 whose length of the intermediate zone 311 is suitable for placing an insert 2 there whose length corresponds to the thickness of the sandwich panel.

In this particular case, it is advantageous that the excess material 121, 122 that is pushed back toward the edges of the hole in each panel 111, 112 is, in the peripheral zone 14 of each panel, pushed back during the calibration stage between the shoulder 322 of the body 32 and the counter-pushed plate 6 beside a surface of the panel that is located beside the core 110 or by deformation of the foam or by creep in the cavities in such a way that the part does not comprise deformation on its outside surfaces in the zone of the hole as illustrated in the cross-section of FIG. 5, in particular the right half-section of the figure that has the part that is made when the perforation tool is removed.

To raise the temperature of the matrix up to the thermoforming temperature Tf, different methods are advantageously implemented according to the process for manufacturing the part 1 and the time when the holes are to be made.

One method consists in making the perforation according to the process that is described when the part 1 is still at a sufficient temperature, greater than or equal to the temperature Tf, at the end of a forming process in a mold during which the temperature has been increased.

In this case, advantageously the mold, or one of its parts, is used as a counter-pushed plate 33 and comprises holes 331 that can be cleared for the passage of the needle 31 to the necessary locations.

Another method consists in locally reheating the material by means outside of the location where a hole is to be made, for example by means of a furnace that locally radiates heat before making the perforation by continuing to heat the part 1 locally if necessary.

Another method consists in supplying the heat that is necessary to the elevation in temperature of the matrix of the part 1 by means of a heating needle 31.

In this case, the needle 31 is made of a good heat-conducting material.

Advantageously, the needle 31 is then heated by conduction from the body 32 that is itself brought to a suitable temperature for bringing the material of the matrix to a temperature that is at least equal to the temperature Tf.

Another method consists in supplying energy to the part 1 by ultrasound by means of the needle 31 when the composite material of the part lends itself to such a heating mode.

When the energy for heating the matrix is supplied by the needle, preferably the free end 315 of the needle is shaped to meet this requirement as well as possible and therefore has a spherical or rounded shape to improve the contact surface in particular at the beginning of the perforation process.

The invention therefore makes it possible to make holes in parts made of composite material whose matrix uses thermoformable characteristics without cutting tools and without cutting the fibers of the material.

The invention also makes it possible to install an insert during the perforation operation itself.

1. Process for making a hole in a part (1) that is essentially formed by fibers (10) that are kept in a matrix (11), whereby said part comprises—in the zone of the hole that is to be made—a first surface, so-called upper surface (12), through which the hole is made, and a second surface, so-called lower surface (13), through which the hole emerges, whereby said matrix essentially consists of a material, so-called thermoplastic material, exhibiting a plastic state when it is brought to a temperature Tf, so-called forming temperature, and exhibiting a non-plastic state when it is at a temperature Tu, so-called temperature of use, less than Tf, characterized in that it comprises the stages of:
a) Locally heating at least at the location of the hole to produce the matrix (11) of the part (1) at the temperature Tf;
b) Moving apart the fibers (10) held by the matrix (11) at the location that is desired for the hole by radially pushing back the material in the plastic state from said matrix relative to a longitudinal axis of the hole in order to form a starter hole from a cross-section that is essentially constant and lower than a cross-section that is desired for the hole;
c) Heating, if necessary, the material of the matrix (11) around the starter hole to the temperature Tf and gradually moving apart the fibers (10) and pushing back the material in the plastic state from the matrix (11) until reaching the essentially constant cross-section that is desired for the hole between the upper surface (12) and the lower surface (13);
d) Cooling the material of the matrix (11) to a temperature Tu, or at least to a temperature that is lower than Tf for which said matrix no longer has a thermoplastic property, by holding the material from the pushed-back matrix (11) and the fibers (10) moved apart around the hole that is made during preceding stages.

2. Process according to claim 1, wherein the part 1 is kept in the zone of the hole that is to be made by a counter-pushed plate (6) while the hole is being made.

3. Process according to claim 1 comprising—after the formation of the hole in stage c) and before the cooling of the part (1) in stage d)—a stage for calibrating the thickness of said part in a peripheral zone (14) of the hole during which pressure is exerted between the upper surface (12) and the lower surface (13) to distribute the material of the part (1) that is pushed back from the location of the hole toward said peripheral zone.

4. Process according to claim 3, wherein the hole is shaped by an indentation of a shape that is applied during the calibration stage.

5. Process according to claim 1 that comprises—after the formation of the hole in stage c) and before the cooling of the part (1) in stage d) and, if necessary, before the calibration stage of said part—a stage for inserting an insert (2) comprising a hole into the hole that is made.

6. Process according to claim 5, wherein the hole of the insert (2) is shaped by an indentation of a shape that is applied during the calibration stage.

7. Process according to claim 1, wherein the heating of the part at the location of the hole that is to be made is carried out during a stage for shaping the part (1) that is independent from the perforation operation.

8. Process according to claim 1, wherein the heating of the part (1) at the location of the hole that is to be made is made locally during the perforation operation by means of heating by radiation or by contact conduction or by ultrasound.

9. Perforation device for making a hole in a part (1) that is formed essentially by fibers (10) that are held in a matrix (11), whereby said part comprises—in the zone of the hole that is to be made—a first surface, so-called upper surface (12), through which the hole is made, and a second surface, so-called lower surface (13), through which the hole emerges, whereby said matrix essentially consists of a material, so-called thermoplastic material, exhibiting a plastic state when it is brought to a temperature Tf, so-called forming temperature, and exhibiting a non-plastic state when it is at a temperature Tu, so-called temperature of use, less than Tf, wherein it comprises a needle (31) that comprises:
i) On the side of one free end (315) of the needle (31), a tapered end (311) of an essentially constant cross-section that is lower than the cross-section of the hole that is to be made in the part (1) and with end length Le;
ii) On the side of the other end, a heel (312) of a cross-section that is essentially constant and equal to the cross-section of the hole that is to be made and with a heel length Lt;
iii) Between the tapered end (311) and the heel (312), a scalable cross-section zone (313) in which the cross-section of the needle (31) gradually changes from the cross-section of the tapered end to the cross-section of the heel.

10. Perforation device according to claim 9, wherein the length of heel Lt is greater than or equal to a thickness of the part (1) at the location of the hole that is to be made.

11. Perforation device according to claim 9, wherein the needle (31) is integral at the heel (312) with a body (32), whereby said body forms a shoulder (322) relative to said heel, and whereby said shoulder forms a support surface on a peripheral zone (14) of the hole when the needle is pushed into the part (1) to form said hole.

12. Perforation device according to claim 11, wherein the body comprises a form (323) that is designed to allow an indentation that corresponds to the geometry of said form in the part (1) on one or more of the edges of the hole or in the hole that is made by said device.

13. Perforation device according to claim 11, wherein the body (32) and the needle (31) can be separated and assembled by means of a cylindrical extension (33) of said body or said needle.

14. Perforation device according to claim 13, wherein the cylindrical extension (33) comprises an intermediate zone (331) of a cross-section that is lower than the cross-section of the heel (312), whereby said intermediate zone is designed to accommodate an insert (2) that has to be set in the hole that is made in the part (1) by the perforation device, the cross-section of said intermediate zone corresponding to the shapes and dimensions of a hole in the insert (2), the shape and the dimensions of the cross-section of said heel corresponding to shapes and dimensions of a cross-section outside of said insert before installation of said insert.

15. Perforation device according to claim 13, wherein the body (32) and the needle (31) comprise, in assembled position, at least a first offset position in which the insert (2) is not deformed and a second closer position in which the insert (2) is deformed when said insert can be shaped plastically at the temperature Tf.

16. Device according to claim 9, wherein the needle (31) is combined with means of heating by radiation or by conduction or by ultrasound of a zone of the part (1) in which said device is to make a hole.

17. Perforation device according to claim 9 that comprises a counter-pushed plate (6) that is designed to be placed on the lower surface (13) of the part (1) in the zone of the hole that is to be made, whereby said counter-pushed plate itself comprises a hole with a cross-section that is at least equal to the cross-section of the heel (312) and that comprises an axis of said hole that is essentially merged with an axis (314) of the needle (31).

18. Process according to claim 2 comprising—after the formation of the hole in stage c) and before the cooling of the part (1) in stage d)—a stage for calibrating the thickness of said part in a peripheral zone (14) of the hole during which pressure is exerted between the upper surface (12) and the lower surface (13) to distribute the material of the part (1) that is pushed back from the location of the hole toward said peripheral zone.

19. Perforation device according to claim 10, wherein the needle (31) is integral at the heel (312) with a body (32), whereby said body forms a shoulder (322) relative to said heel, and whereby said shoulder forms a support surface on a peripheral zone (14) of the hole when the needle is pushed into the part (1) to form said hole.

20. Perforation device according to claim 12, wherein the body (32) and the needle (31) can be separated and assembled by means of a cylindrical extension (33) of said body or said needle.
